(19) United States
(12) Patent Application Publication
(10) Pub. No.: US 2023/0022226 A1
(43) Pub. Date: Jan. 26, 2023

(54) AUTOMATED STORAGE ACCESS CONTROL FOR CLUSTERS

(71) Applicant: VMware, Inc., Palo Alto, CA (US)

(72) Inventors: Sandeep Srinivasa Pissay Srinivasa Rao, Sunnyvale, CA (US); Christian DICKMAN, Palo Alto, CA (US); Balu DONTU, Palo Alto, CA (US); Raunak SHAH, Palo Alto, CA (US)

(21) Appl. No.: 17/382,461

(22) Filed: Jul. 22, 2021

(51) Int. Cl. H04L 29/06; G06F 9/455; G06F 21/62

(52) U.S. Cl. CPC H04L 63/101; G06F 9/45558; G06F 21/6218; G06F 2009/45583; G06F 2009/45595

(57) ABSTRACT

A method for dynamic access control in a virtual storage environment is provided. Embodiments include providing, by a component within a cluster of virtual computing instances (VCIs), one or more computing node identifiers associated with the cluster to a management entity associated with a file volume. Embodiments include modifying, by the management entity, an access control list associated with the file volume based on the one or more computing node identifiers. Embodiments include determining, by the component, a configuration change related to the cluster. Embodiments include providing, by the component, based on the configuration change, an updated one or more computing node identifiers associated with the cluster to the management entity. Embodiments include modifying, by the management entity, the access control list associated with the file volume based on the updated one or more computing node identifiers.

### BACKGROUND

Distributed systems allow multiple clients in a network to access shared resources. For example, a distributed storage system, such as a distributed virtual storage area network (vSAN), allows a plurality of host computers to aggregate local disks (e.g., SSD, PCI-based flash storage, SATA, or SAS magnetic disks) located in or attached to each host computer to create a single and shared pool of storage. Storage resources within the distributed storage system, may be shared by particular clients, such as virtual computing instances (VCIs) running on the host computers, for example, to store objects (e.g., virtual disks) that are accessed by the VCIs during their operations.

Thus, a VCI may include one or more objects (e.g., virtual disks) that are stored in an object-based datastore (e.g., vSAN) of the datacenter. Each object may be associated with access control rules that define which entities are permitted to access the object. For example, access control rules for an object may include a list of identifiers of VCIs (e.g., network addresses, media access control (MAC) addresses, and/or the like). Thus, a management entity of the vSAN may limit access to a given object based on the access control rules.

Modern networking environments are increasingly dynamic, however, and network configuration changes may occur frequently. Furthermore, objects may be shared by groups of VCIs (e.g., in clusters) with dynamic definitions and/or configurations. For example, a virtual disk may be associated with a cluster of VCIs, and VCIs within a cluster may be frequently added, removed, migrated between hosts, and otherwise reconfigured. Thus, any access control rules for an object shared by VCIs in a cluster may frequently become outdated, such as due to changing IP addresses of the VCIs in the cluster, as well as addition and removal of VCIs from the cluster. On the other hand, allowing unrestricted access to an object in a networking environment is problematic due to security and privacy concerns.

As such, there is a need in the art for improved techniques of controlling access to shared storage resources in dynamic networking environments.

### BRIEF DESCRIPTION OF THE DRAWINGS

FIG. 1 is a diagram illustrating an example computing environment in which embodiments of the present application may be practiced.

FIG. 2 is a diagram illustrating example components related to automated storage access control.

FIG. 3 is a diagram illustrating an example related to automated storage access control.

FIG. 4 illustrates example operations for automated storage access control.

### DETAILED DESCRIPTION

In a distributed object-based datastore, such as vSAN, objects (e.g., a virtual disk of one or more VCIs stored as a virtual disk file, data, etc.) are associated with access control rules that specify which entities (e.g., VCIs, clusters, pods, etc.) are permitted to access the objects. In order to allow objects to be adapted to changing circumstances, such as the addition and removal of VCIs from clusters, the migration of VCIs between hosts, the addition and removal of hosts in a vSAN, and the like, techniques described herein involve automated access control configuration for objects. As will be described in more detail below, access control rules for an object are automatically created, updated, and removed based on network configuration changes, particularly related to clusters of VCIs, in order to enable dynamic access control in changing networking environments.

In one embodiment, a virtual disk is shared among a cluster of VCIs. The cluster may, for example, be an instance of a solution such as platform as a service (PAAS) or container as a service (CAAS), and may include containers that are created within various VCIs on a hypervisor. Platform as a service (PAAS) and container as a service (CAAS) solutions like Kubernetes®, OpenShift®, Docker Swarm®, Cloud Foundry®, and Mesos® provide application level abstractions that allow developers to deploy, manage, and scale their applications. PAAS is a service that provides a platform that allows users to develop, run, and manage applications without the complexity of building and maintaining the infrastructure typically associated with launching an application. For example, a user can control software deployment with minimal configuration options, while the PAAS provides services to host the user's application. CAAS is a form of container-based virtualization in which container engines, orchestration, and the underlying compute resources are delivered to users as a service from a cloud provider. These solutions provide support for compute and storage but do not generally provide native networking support. As such, software defined networking (SDN) is utilized to provide networking for the containers. For example, after a new container is scheduled for creation, an SDN control plane generates network interface configuration data that can be used by the container host VM (i.e., the VM hosting the container) to configure a network interface for the container. The configured network interface for the container enables network communication between the container and other network entities, including containers hosted by other VMs on the same or different hosts.

In some embodiments, a service instance is implemented in the form of a pod that includes multiple containers, including a main container and one or more sidecar containers, which are responsible for supporting the main container. For instance, a main container may be a content server and a sidecar container may perform logging functions for the content server, with the content server and the logging sidecar container sharing resources such as storage associated with the pod. A cluster (e.g., including one or more service instances) may include one or more pods, individual containers, namespace containers, docker containers, VMs, and/or other VCIs. Thus, if data is utilized by an application that is executed as a cluster of VCIs that perform the functionality of the application, there is a need to ensure that only the specific VCIs in the cluster where the application is deployed can access the data. Pods and other VCIs in the cluster could crash and restart in different worker nodes (e.g., host computers and/or host VMs) and/or otherwise be moved, added, and/or removed. Accordingly, embodiments of the present disclosure involve automated dynamic configuration of access control rules for storage objects based on network configuration changes. For instance, a component within a cluster may provide information about the network configuration of the cluster on an ongoing basis, as configuration changes occur, to a component within a virtualization manager that causes access control rules for one or more storage objects to be updated based on the information. In one example, network addresses currently associated with VCIs in the cluster are determined on a regular basis by the component in the cluster and provided to the component in the virtualization manager for use in updating the access control rules such that access to a given storage object is limited to those network addresses currently associated with VCIs in the cluster.

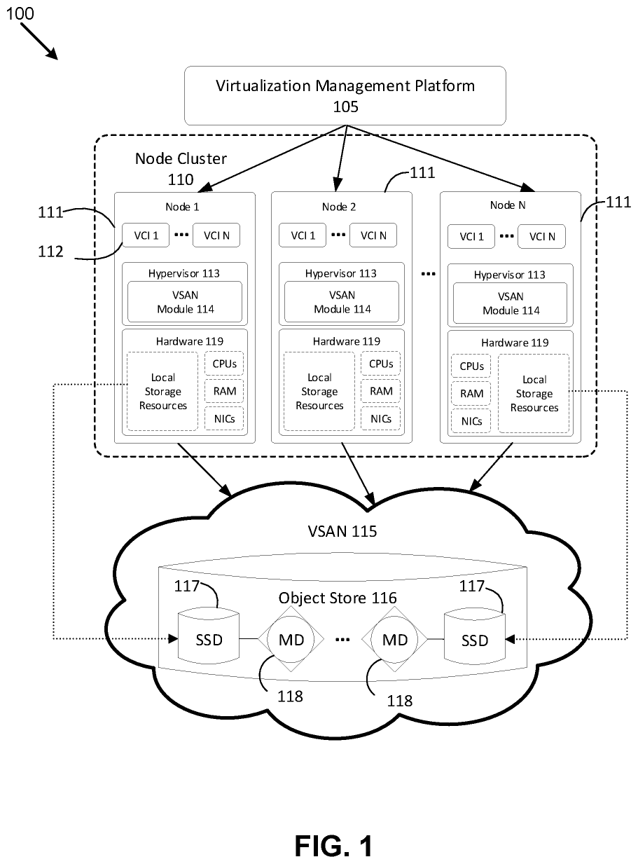

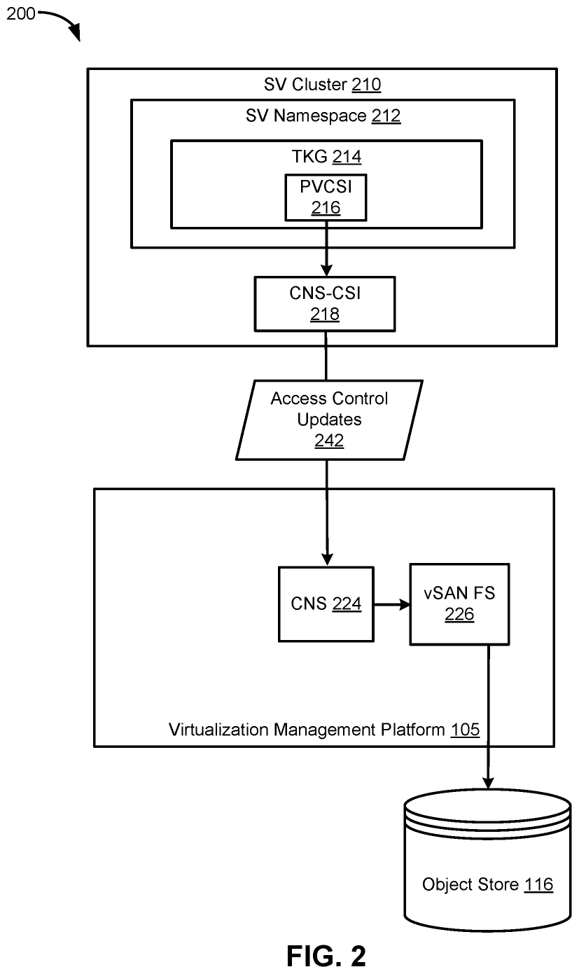

FIG. 1 is a diagram illustrating an example computing environment 100 in which embodiments of the present application may be practiced. For example, access control rules for storage objects described with respect to FIG. 1 may be dynamically configured in an automated fashion as described in more detail below with respect to FIGS. 2-4.

As shown, computing environment 100 includes a distributed object-based datastore, such as a software-based “virtual storage area network” (vSAN) environment that leverages the commodity local storage housed in or directly attached (hereinafter, use of the term “housed” or “housed in” may be used to encompass both housed in, or otherwise directly attached) to host machines/servers or nodes 111 of a storage cluster 110 to provide an aggregate object store 116 to VCIs 112 running on the nodes. The local commodity storage housed in the nodes 111 may include one or more of solid state drives (SSDs) or non-volatile memory express (NVMe) drives 117, magnetic or spinning disks or slower/cheaper SSDs 118, or other types of storages.

In certain embodiments, a hybrid storage architecture may include SSDs 117 that may serve as a read cache and/or write buffer (e.g., also known as a performance/cache tier of a two-tier datastore) in front of magnetic disks or slower/cheaper SSDs 118 (e.g., in a capacity tier of the two-tier datastore) to enhance the I/O performances. In certain other embodiments, an all-flash storage architecture may include, in both performance and capacity tiers, the same type of storage (e.g., SSDs 117) for storing the data and performing the read/write operations. Additionally, it should be noted that SSDs 117 may include different types of SSDs that may be used in different layers (tiers) in some embodiments. For example, in some embodiments, the data in the performance tier may be written on a single-level cell (SLC) type of SSD, while the capacity tier may use a quad-level cell (QLC) type of SSD for storing the data. In some embodiments, each node 111 may include one or more disk groups with each disk group having one cache storage (e.g., one SSD 117) and one or more capacity storages (e.g., one or more magnetic disks and/or SSDs 118).

Each node 111 may include a storage management module (referred to herein as a “vSAN module”) in order to automate storage management workflows (e.g., create objects in the object store, etc.) and provide access to objects in the object store (e.g., handle I/O operations on objects in the object store, etc.) based on predefined storage policies specified for objects in the object store. For example, because a VCI or set of VCIs (e.g., cluster) may be initially configured by an administrator to have specific storage requirements (or policy) for its “virtual disk” depending on its intended use (e.g., capacity, availability, performance or input/output operations per second (IOPS), etc.), the administrator may define a storage profile or policy for each VCI or set of VCIs specifying such availability, capacity, performance and the like. As further described below, the vSAN module may then create an “object” for the specified virtual disk by backing it with physical storage resources of the object store based on the defined storage policy.

A virtualization management platform 105 is associated with cluster 110 of nodes 111. Virtualization management platform 105 enables an administrator to manage the configuration and spawning of the VMs on the various nodes 111. As depicted in the embodiment of FIG. 1, each node 111 includes a virtualization layer or hypervisor 113, a vSAN module 114, and hardware 119 (which includes the SSDs 117 and magnetic disks 118 of a node 111). Through hypervisor 113, a node 111 is able to launch and run multiple VCIs 112. Hypervisor 113, in part, manages hardware 119 to properly allocate computing resources (e.g., processing power, random access memory, etc.) for each VCI 112. Furthermore, as described below, each hypervisor 113, through its corresponding vSAN module 114, may provide access to storage resources located in hardware 119 (e.g., SSDs 117 and magnetic disks 118) for use as storage for storage objects, such as virtual disks (or portions thereof) and other related files that may be accessed by any VCI 112 residing in any of nodes 111 in cluster 110.

In one embodiment, vSAN module 114 may be implemented as a “vSAN” device driver within hypervisor 113. In such an embodiment, vSAN module 114 may provide access to a conceptual “vSAN” 115 through which an administrator can create a number of top-level “device” or namespace objects that are backed by object store 116. For example, during creation of a device object, the administrator may specify a particular file system for the device object (such device objects may also be referred to as “file system objects” hereinafter) such that, during a boot process, each hypervisor 113 in each node 111 may discover a /vsan/ root node for a conceptual global namespace that is exposed by vSAN module 114. By accessing APIs exposed by vSAN module 114, hypervisor 113 may then determine all the top-level file system objects (or other types of top-level device objects) currently residing in vSAN 115.

When a VCI (or other client) attempts to access one of the file system objects, hypervisor 113 may then dynamically “auto-mount” the file system object at that time. In certain embodiments, file system objects may further be periodically “auto-unmounted” when access to objects in the file system objects cease or are idle for a period of time. A file system object (e.g., /vsan/fs_name1, etc.) that is accessible through vSAN 115 may, for example, be implemented to emulate the semantics of a particular file system, such as a distributed (or clustered) virtual machine file system (VMFS) provided by VMware Inc. VMFS is designed to provide concurrency control among simultaneously accessing VMs. Because vSAN 115 supports multiple file system objects, it is able to provide storage resources through object store 116 without being confined by limitations of any particular clustered file system. For example, many clustered file systems may only scale to support a certain amount of nodes 111. By providing multiple top-level file system object support, vSAN 115 may overcome the scalability limitations of such clustered file systems.

In some embodiments, a file system object may, itself, provide access to a number of virtual disk descriptor files accessible by VCIs 112 running in cluster 110. These virtual disk descriptor files may contain references to virtual disk “objects” that contain the actual data for the virtual disk and are separately backed by object store 116. A virtual disk object may itself be a hierarchical, “composite” object that is further composed of “components” (again separately backed by object store 116) that reflect the storage requirements (e.g., capacity, availability, IOPs, etc.) of a corresponding storage profile or policy generated by the administrator when initially creating the virtual disk. Each vSAN module 114 (through a cluster level object management or “CLOM” sub-module, in embodiments as further described below) may communicate with other vSAN modules 114 of other nodes 111 to create and maintain an in-memory metadata database (e.g., maintained separately but in synchronized fashion in the memory of each node 111) that may contain metadata describing the locations, configurations, policies and relationships among the various objects stored in object store 116, such as including access control rules associated with objects. In certain embodiments, as described in more detail below with respect to FIGS. 2-4, the access control rules for an object are automatically created and/or updated on an ongoing basis as network configuration changes occur.

The in-memory metadata database is utilized by a vSAN module 114 on a node 111, for example, when a user (e.g., an administrator) first creates a virtual disk for a VCI or cluster of VCIs, as well as when the VCI or cluster of VCIs is running and performing I/O operations (e.g., read or write) on the virtual disk. vSAN module 114 (through a distributed object manager or “DOM” sub-module), in some embodiments, may traverse a hierarchy of objects using the metadata in the in-memory database in order to properly route an I/O operation request to the node (or nodes) that houses (house) the actual physical local storage that backs the portion of the virtual disk that is subject to the I/O operation. Furthermore, the vSAN module 114 on a node 111 may utilize access control rules of an object to determine whether a particular VCI 112 should be granted access to the object.

In some embodiments, one or more nodes 111 of node cluster 110 may be located at a geographical site that is distinct from the geographical site where the rest of nodes 111 are located. For example, some nodes 111 of node cluster 110 may be located at building A while other nodes may be located at building B. In another example, the geographical sites may be more remote such that one geographical site is located in one city or country and the other geographical site is located in another city or country. In such embodiments, any communications (e.g., I/O operations) between the DOM sub-module of a node at one geographical site and the DOM sub-module of a node at the other remote geographical site may be performed through a network, such as a wide area network (“WAN”).

FIG. 2 is a diagram 200 illustrating example components related to automated storage access control. Diagram 200 includes virtualization management platform 105 and object store 116 of FIG. 1.

An SV cluster 210 represents a supervisor (SV) cluster of VCIs, which generally allows an administrator to create and configure clusters (e.g., VMWare® Tanzu® Kubernetes Grid® (TKG) clusters, which may include pods) in an SDN environment, such as networking environment 100 of FIG. 1. While certain types of clusters do not offer native networking support, TKG provides network connectivity and allows such clusters to be integrated with an SDN environment. SV cluster 210 comprises an SV namespace 212, which is an abstraction that is configured with a particular resource quota, user permissions, and/or other configuration properties, and provides an isolation boundary (e.g., based on rules that restrict access to resources based on namespaces) within which clusters, pods, containers, and other types of VCIs may be deployed. Having different namespaces allows an administrator to control resources, permissions, etc. associated with entities within the namespaces.

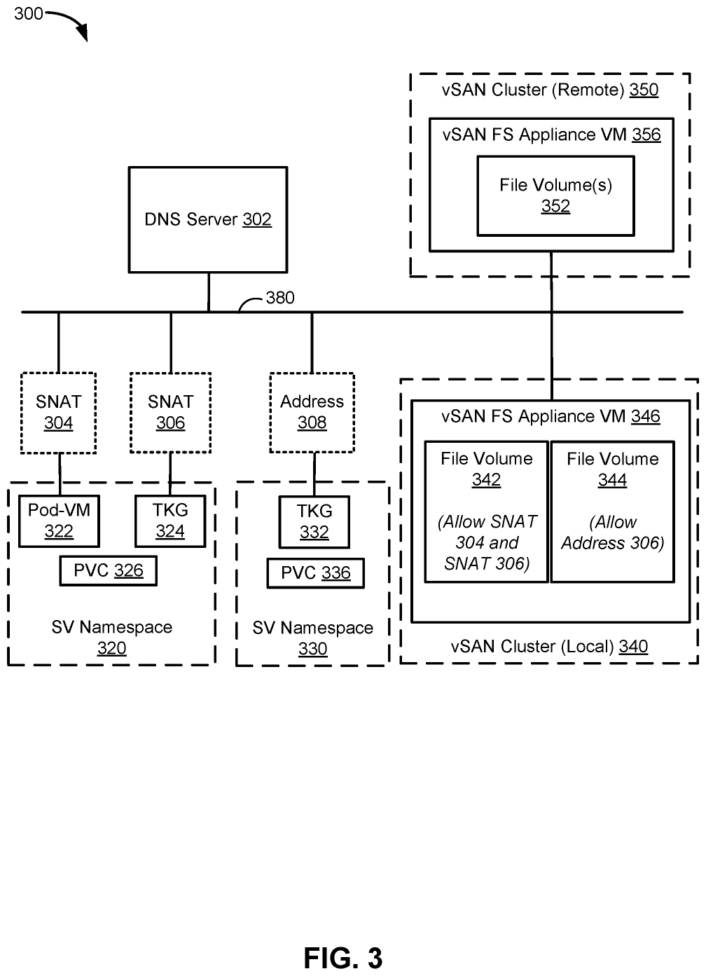

A TKG cluster 214 is created within SV namespace 212. TKG cluster 214 may include one or more pods, containers, and/or other VCIs. TKG cluster 214 comprises a paravirtual container storage interface (PVCSI) 216, which may run within a VM on which one or more VCIs in TKG cluster 214 reside and/or on one or more other physical or virtual components. Paravirtualization allows virtualized components to communicate with the hypervisor (e.g., via “hypercalls”), such as to enable more efficient communication between the virtualized components and the underlying host. For example, PVCSI 216 may communicate with a hypervisor in order to receive information about configuration changes related to TKG cluster 214. According to certain embodiments, PVCSI 216 is notified via a callback when a configuration change related to TKG cluster 214 occurs, such as a pod moving to a different host VM. PVCSI 216 then provides information related to the configuration change to cloud native storage container storage interface (CNS-CSI) 218, which runs in SV cluster 210 outside of SV namespace 212 (e.g., on a VCI in SV cluster 210). The information related to the configuration change may include, for example, one or more network addresses and/or other identifiers associated with one or more VCIs in the cluster, such as a network address of a VM to which a pod was added and/or a network address of a VM from which a pod was removed. In some embodiments, as described in more detail below with respect to FIG. 3, the information may include a source network address translation (SNAT) internet protocol (IP) address. In some embodiments, CNS-CSI 218 determines whether one or more changes need to be made to access control rules for one or more storage objects, such as a virtual disk shared among VCIs in TKG cluster 214, based on the information related to the configuration change.

CNS-CSI 218 provides access control updates 242, which may include information related to the configuration change such as one or more network address and/or other identifiers, to cloud native storage (CNS) component 224 within virtualization management platform 105 so that access control rule changes may be made as appropriate. CNS component 224 communicates with vSAN file services (FS) 226 in order to cause one or more changes to be made to access control rules for one or more objects within object store 116. For instance, vSAN FS 226 may be an appliance VM that performs operations related to managing file volumes in object store 116, and may add and/or remove one or more network addresses and/or other identifiers from an access control list associated with a virtual disk object in object store 116. Thus, techniques described herein allow access control rules for storage objects to be dynamically updated in an automated fashion as configuration changes occur in a networking environment.

It is noted that the particular types of entities described herein, such as namespaces, pods, containers, clusters, vSAN objects, SDN environments, and the like, are included as examples, and techniques described herein for dynamic automated storage access control may be implemented with other types of entities and in other types of computing environments.

FIG. 3 is a diagram 300 illustrating an example related to automated storage access control.

A domain name system (DNS) server 302 is connected to a network 380, such as a layer 3 (L3) network, and generally performs operations related to resolving domain names to network addresses.

An SV namespace 320 comprises a pod-VM 322 and a TKG cluster 324, which are exposed to network 380 via, respectively, SNAT address 304 and SNAT address 306.

Pod-VM 322 is a VM that functions as a pod (e.g., with a main container and one or more sidecar containers). TKG cluster 322 is a cluster of VCIs, such as pods, containers, and/or the like, which may run on a VM. Pod-VM 322 and TKG cluster 324 are each behind a tier 1 (T1) logical router that provides source network address translation (SNAT) functionality. SNAT generally allows traffic from an endpoint in a private network (e.g., SV namespace 320) to be sent on a public network (e.g., network 380) by replacing a source IP address of the endpoint with a different public IP address, thereby protecting the actual source IP address of the endpoint. Thus, SNAT address 304 and SNAT address 306 are public IP addresses for pod-VM 322 and TKG cluster 324 that are different than private IP addresses for these two entities.

A persistent volume claim (PVC) 326 is configured within SV namespace 320, and specifies a claim to a particular file volume, such as file volume 342, which may be a virtual disk. A PVC is a request for storage that is generally stored as a file volume in a namespace, and entities within the namespace use the PVC as a file volume, with the cluster on which the namespace resides accessing the underlying file volume (e.g., file volume 342) based on the PVC. Thus, because PVC 326 is specified within SV namespace 320, the file volume claimed by PVC 326 is shared between pod-VM 322 and TKG cluster 324.

Another SV namespace 330 comprises a TKG cluster 332, which is exposed to network 380 via TKG-2 address 308. TKG cluster 332 is a cluster of VCIs, such as pods, containers, and/or the like, which may run on a VM. Unlike TKG cluster 324, TKG cluster 332 is not behind an SNAT address, and so address 308 is the actual IP address of TKG cluster 332. A PVC 336 is specified within SV namespace 330, such as indicating a claim to file volume 344.

SV namespace 320 and/or SV namespace 330 may be similar to SV namespace 212 of FIG. 2, and pod VM 322, TKG 324, and/or TKG 332 may each include one or more PVCSIs, similar to PVCSI 216 of FIG. 2. While not shown, SV namespace 320 and/or SV namespace 330 may be included within the same or different supervisor clusters, similar to SV cluster 210 of FIG. 2, with one or more CNS-CSIs, similar to CNS-CSI 218 of FIG. 1.

A vSAN cluster 340 is connected to network 380, and represents a local vSAN cluster, such as within the same data center as SV namespace 320 and/or 330. A remote vSAN cluster 350 is also connected to network 350, and may be located, for example, on a separate data center.

vSAN cluster 340 and/or vSAN cluster 350 may be similar to node cluster 110 of vSAN 115 of FIG. 1, and may each include a plurality of nodes with hypervisors that abstract physical resources of the nodes for VCIs that run on the nodes. Furthermore, vSAN cluster 340 and vSAN cluster 350 may each be associated with a virtualization manager, similar to virtualization management platform 105 of FIGS. 1 and 2, that includes a CNS, similar to CNS 224 of FIG. 2.

vSAN cluster 340 and vSAN cluster 350 include, respectively, vSAN FS appliance VM 346 and vSAN FS appliance VM 356, each of which may be similar to vSAN FS 226 of FIG. 2. vSAN FS appliance VM 346 comprises file volumes 342 and 344, and vSAN FS appliance VM 356 comprises one or more file volumes 352. Access control rules for file volumes 342, 344, and 352 may be dynamically created and/or updated in an automated fashion according to techniques described herein.

In an example, a CNS-CSI associated with SV namespace 320 determines that file volume 342 should be accessible by pod-VM 322 and TKG cluster 324 based on PVC 326. Furthermore, the CNS-CSI determines based on communication with one or more PVCSIs associated with pod-VM 322 and TKG cluster 324 that pod-VM 322 has a public IP address represented by SNAT address 304 and that TKG cluster 324 has a public IP address represented by SNAT address 306. As such, the CNS-CSI sends SNAT address 304 and SNAT address 306 to a CNS component of a virtualization manager associated with vSAN cluster 340 so that access control rules for file volume 342 may be set accordingly. The CNS component may communicate with vSAN FS appliance VM 346 in order to set access control rules for file volume 342 to allow SNAT address 304 and SNAT address 306 to access file volume 342. For example, an access control rule may specify that request packets having a source IP address of SNAT address 304 or SNAT address 306 are to be serviced, and responses to such requests may be sent to SNAT address 304 or SNAT address 306 as a destination. The access control rules may comprise an access control list that includes identifiers and/or network addresses of entities that are allowed to access file volume 342.

Likewise, a CNS-CSI associated with SV namespace 330 determines that file volume 344 should be accessible by TKG cluster 332 based on PVC 336. Furthermore, the CNS-CSI determines based on communication with one or more PVCSIs associated with TKG cluster 332 that TKG cluster 332 has a public IP address represented by address 308. As such, the CNS-CSI sends address 308 to the CNS component of the virtualization manager associated with vSAN cluster 340 so that access control rules for file volume 344 may be set accordingly. The CNS component may communicate with vSAN FS appliance VM 346 in order to set access control rules for file volume 344 to allow address 308 to access file volume 344.

While not shown, similar techniques may be used to dynamically create and update access control rules for file volumes 352 of remote vSAN cluster 350 based on additional PVCs (not shown) in SV namespaces 320 and/or 330, and/or in other namespaces or clusters.

As network configuration changes occur over time, such as addition or removal of a VCI from a cluster, movement of a VCI from one host machine or host VM to another, and/or other changes in identifiers such as network addresses associated with VCIs, the process described above may be utilized to continually update access control rules associated with file volume. For example, network addresses may be automatically added and/or removed from access control lists of file volumes as appropriate based on configuration changes. In some cases, once the last VCI scheduled on a worker node is deleted, the access control configuration for that worker node is removed from the file volume automatically so that the worker node can no longer access the file volume.

While certain embodiments described herein involve networking environments, alternative embodiments may not involve networking. For example, access control rules for a file volume that is located on the same physical device as one or more VCIs may be automatically and dynamically added and/or updated in a similar manner to that described above. For instance, rather than network addresses, other identifiers of VCIs such as MAC addresses or names assigned to the VCIs may be used in the access control rules. Rather than over a network, communication may be performed locally, such as using VSOCK, which facilitates communication between VCIs and the host they are running on.

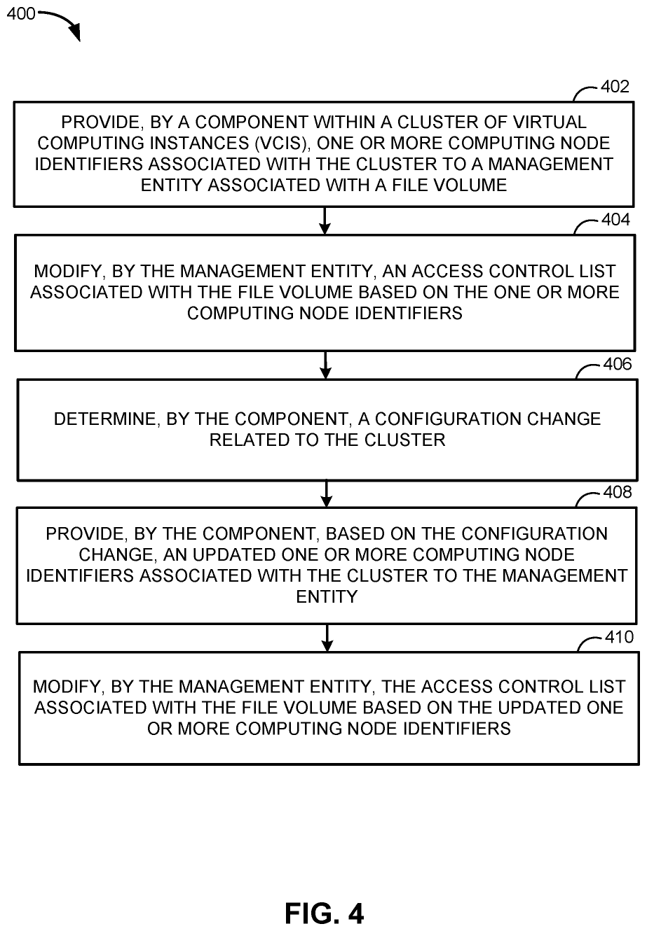

FIG. 4 is a flowchart illustrating example operations 400 for automated storage access control, according to an example embodiment of the present application. Operations 400 may be performed, for example, by one or more components such as PVCSI 216, CNS-CSI 218, CNS 224, and/or vSAN FS 226 of FIG. 2, and/or one or more alternative and/or additional components.

Operations 400 begin at step 402, with providing, by a component within a cluster of virtual computing instances (VCIs), one or more computing node identifiers associated with the cluster to a management entity associated with a file volume. In some embodiments the one or more computing node identifiers comprise an Internet protocol (IP) address of a computing node on which a VCI of the cluster resides. In some embodiments, the cluster of VCIs comprises one or more pods, and the one or more computing node identifiers may correspond to the one or more pods.

In certain embodiments, the one or more computing node identifiers comprise one or more source network address translation (SNAT) addresses. The file volume may, for example, comprise a virtual storage area network (VSAN) disk created for the cluster.

Operations 400 continue at step 404, with modifying, by the management entity, an access control list associated with the file volume based on the one or more computing node identifiers.

Operations 400 continue at step 406, with determining, by the component, a configuration change related to the cluster. In certain embodiments, determining, by the component, the configuration change related to the cluster comprises determining that the VCI has moved from the computing node to a different computing node. The computing node and/or the different computing node may, for example, comprise virtual machines (VMs).

Operations 400 continue at step 408, with providing, by the component, based on the configuration change, an updated one or more computing node identifiers associated with the cluster to the management entity. The updated one or more computing node identifiers may comprise an IP address of a different computing node to which a VCI has moved.

Operations 400 continue at step 410, with modifying, by the management entity, the access control list associated with the file volume based on the updated one or more computing node identifiers.

Some embodiments further comprise receiving, by the management entity, an indication from the component that all VCIs have been removed from the cluster and removing, by the management entity, one or more entries from the access control list related to the cluster.

Techniques described herein allow access to storage objects to be dynamically controlled in an automated fashion despite ongoing configuration changes in a networking environment. Thus, embodiments of the present disclosure increase security by ensuring that only those entities currently associated with a given storage object are enabled to access the given storage object. Furthermore, techniques described herein avoid the effort and delays associated with manual configuration of access control rules for storage objects, which may result in out-of-date access control rules and, consequently poorly-functioning and/or unsecure access control mechanisms. Thus, embodiments of the present disclosure improve the technology of storage access control.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

In addition, while described virtualization methods have generally assumed that virtual machines present interfaces consistent with a particular hardware system, the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method for dynamic access control in a virtual storage environment, comprising:
providing, by a component within a cluster of virtual computing instances (VCIs), one or more computing node identifiers associated with the cluster to a management entity associated with a file volume;
modifying, by the management entity, an access control list associated with the file volume based on the one or more computing node identifiers;
determining, by the component, a configuration change related to the cluster;
providing, by the component, based on the configuration change, an updated one or more computing node identifiers associated with the cluster to the management entity; and
modifying, by the management entity, the access control list associated with the file volume based on the updated one or more computing node identifiers.

2. The method of claim 1, wherein the one or more computing node identifiers comprise an internet protocol (IP) address of a computing node on which a VCI of the cluster resides.

3. The method of claim 2, wherein determining, by the component, the configuration change related to the cluster comprises determining that the VCI has moved from the computing node to a different computing node, and wherein the updated one or more computing node identifiers comprise an IP address of the different computing node.

4. The method of claim 3, wherein the computing node and the different computing node comprise virtual machines (VMs).

5. The method of claim 1, further comprising:
receiving, by the management entity, an indication from the component that all VCIs have been removed from the cluster; and
removing, by the management entity, one or more entries from the access control list related to the cluster.

6. The method of claim 1, wherein the cluster of VCIs comprises one or more pods, and wherein the one or more computing node identifiers correspond to the one or more pods.

7. The method of claim 1, wherein the one or more computing node identifiers comprise one or more source network address translation (SNAT) addresses.

8. The method of claim 1, wherein the file volume comprises a virtual storage area network (VSAN) disk created for the cluster.

9. A system for dynamic access control in a virtual storage environment, comprising:
at least one memory; and
at least one processor coupled to the at least one memory, the at least one processor and the at least one memory configured to:
provide, by a component within a cluster of virtual computing instances (VCIs), one or more computing node identifiers associated with the cluster to a management entity associated with a file volume;
modify, by the management entity, an access control list associated with the file volume based on the one or more computing node identifiers;
determine, by the component, a configuration change related to the cluster;
provide, by the component, based on the configuration change, an updated one or more computing node identifiers associated with the cluster to the management entity; and
modify, by the management entity, the access control list associated with the file volume based on the updated one or more computing node identifiers.

10. The system of claim 9, wherein the one or more computing node identifiers comprise an internet protocol (IP) address of a computing node on which a VCI of the cluster resides.

11. The system of claim 10, wherein determining, by the component, the configuration change related to the cluster comprises determining that the VCI has moved from the computing node to a different computing node, and wherein the updated one or more computing node identifiers comprise an IP address of the different computing node.

12. The system of claim 11, wherein the computing node and the different computing node comprise virtual machines (VMs).

13. The system of claim 9, wherein the at least one processor and the at least one memory are further configured to:
receive, by the management entity, an indication from the component that all VCIs have been removed from the cluster; and
remove, by the management entity, one or more entries from the access control list related to the cluster.

14. The system of claim 9, wherein the cluster of VCIs comprises one or more pods, and wherein the one or more computing node identifiers correspond to the one or more pods.

15. The system of claim 9, wherein the one or more computing node identifiers comprise one or more source network address translation (SNAT) addresses.

16. A non-transitory computer-readable medium storing instructions that, when executed by one or more processors, cause the one or more processors to:
provide, by a component within a cluster of virtual computing instances (VCIs), one or more computing node identifiers associated with the cluster to a management entity associated with a file volume;
modify, by the management entity, an access control list associated with the file volume based on the one or more computing node identifiers;
determine, by the component, a configuration change related to the cluster;
provide, by the component, based on the configuration change, an updated one or more computing node identifiers associated with the cluster to the management entity; and
modify, by the management entity, the access control list associated with the file volume based on the updated one or more computing node identifiers.

17. The non-transitory computer-readable medium of claim 16, wherein the one or more computing node identifiers comprise an internet protocol (IP) address of a computing node on which a VCI of the cluster resides.

18. The non-transitory computer-readable medium of claim 17, wherein determining, by the component, the configuration change related to the cluster comprises determining that the VCI has moved from the computing node to a different computing node, and wherein the updated one or more computing node identifiers comprise an IP address of the different computing node.

19. The non-transitory computer-readable medium of claim 18, wherein the computing node and the different computing node comprise virtual machines (VMs).

20. The non-transitory computer-readable medium of claim 16, wherein the instructions, when executed by one or more processors, further cause the one or more processors to:
receive, by the management entity, an indication from the component that all VCIs have been removed from the cluster; and
remove, by the management entity, one or more entries from the access control list related to the cluster.
